(19) United States
(12) Patent Application Publication
(10) Pub. No.: US 2016/0246683 A1
(43) Pub. Date: Aug. 25, 2016

(54) CLONE VOLUME MERGING

(71) Applicant: NetApp Inc., Sunnyvale, CA (US)

(72) Inventors: Anoop Chakkalakkal Vijayan, Bangalore (IN); Sudhakar Jha, Bangalore (IN); Prasad Srinivas, Bangalore (IN)

(21) Appl. No.: 14/627,497

(22) Filed: Feb. 20, 2015

(51) Int. Cl. G06F 11/14; G06F 17/30

(52) U.S. Cl. CPC G06F 11/1464; G06F 17/30088; G06F 17/30215; G06F 2201/84

(57) ABSTRACT

One or more techniques and/or systems are provided for clone volume merging. For example, a parent volume may be exposed to users for read and write access to data stored within the parent volume. The parent volume may be cloned to create a cloned volume of the parent volume. The cloned volume may be exposed to users for data access. Responsive to receiving a clone volume merge command, data blocks within the cloned volume may be compared with data blocks within the parent volume to identify delta data blocks within the cloned volume that are not within the parent volume. The delta data blocks may be copied from the cloned volume to the parent volume, which may increase performance and/or decrease time taken to generate a volume with both common data blocks and the delta data blocks, as compared to copying data from the parent volume to the cloned volume.

### BACKGROUND

Many computing environments may store data within volumes. For example, a company may provide users with read and write access to data stored within a volume, such as access to an enterprise financial software application and a database of financial data stored within the volume. An administrator of the enterprise financial software application may want to test a software update for the enterprise financial software application without risking a crash, a data loss, or user access interruption to the volume and data therein. Accordingly, the administrator may create a clone of the volume to create a cloned volume. In an example, the cloned volume may appear to users as comprising data from the volume, but may actually comprise references to the data. Thus, when the administrator attempts to access, through the cloned volume, a file exposed through the cloned volume, a reference to the file may be used to copy the file from the volume to the cloned volume as copied data that the administrator may access from within the cloned volume. In this way, the cloned volume may conserve storage resources because data may be copied from the volume to the cloned volume on demand when the data is requested. For example, if the volume comprises ten 1 GB files, then the cloned volume may initially comprise references to the ten 1 GB files, where a reference may comprise significantly less data than a file (e.g., less than a megabyte of data). If the software update is used to update a single 1 GB file, then a reference may be used to copy the 1 GB file from the volume to the cloned volume. The software update may modify the 1 GB file resulting in a modified 1.1 GB file. Thus, the cloned volume may comprise around 1.1 GB of data.

In an example, the administrator may determine that the software update is ready for production. The administrator may perform a clone split operation where the remaining nine 1 GB files are copied from the volume to the cloned volume, thus resulting in the cloned volume becoming an independent volume (e.g., as opposed to having a child relationship with the volume as a parent volume). The cloned volume may be renamed to reflect a name of the volume (e.g., the cloned volume may be unmounted, renamed, and then remounted), and may be exposed to clients for access. Unfortunately, copying the nine 1 GB files from the volume to the cloned volume may be an inefficient use of processing resources because merely 1 GB of data or less may have been changed in the cloned volume. Copying the 9 GBs of data may result in extended downtime of client access to data and/or system processing slowdown due to resource utilization for a copy operation.

### DESCRIPTION OF THE DRAWINGS

FIG. 1 is a component block diagram illustrating an example clustered network in accordance with one or more of the provisions set forth herein.

FIG. 2 is a component block diagram illustrating an example data storage system in accordance with one or more of the provisions set forth herein.

FIG. 3 is a flow chart illustrating an exemplary method of clone volume merging.

FIG. 4A is a component block diagram illustrating an exemplary system for clone volume merging, where a cloned volume is created.

FIG. 4B is a component block diagram illustrating an exemplary system for clone volume merging, where a file is copied to a cloned volume for user access.

FIG. 4C is a component block diagram illustrating an exemplary system for clone volume merging, where a file within a cloned volume is modified.

FIG. 4D is a component block diagram illustrating an exemplary system for clone volume merging, where a new file is created within a cloned volume.

FIG. 4E is a component block diagram illustrating an exemplary system for clone volume merging, where snapshots of a parent volume and a cloned volume are created.

FIG. 4F is a component block diagram illustrating an exemplary system for clone volume merging, where delta data blocks are copied from a cloned volume to a parent volume.

FIG. 5 is an example of a computer readable medium in accordance with one or more of the provisions set forth herein.

### DETAILED DESCRIPTION

Some examples of the claimed subject matter are now described with reference to the drawings, where like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. Nothing in this detailed description is admitted as prior art.

One or more systems and/or techniques for clone volume merging are provided. A parent volume may be exposed to users for read and write access to data stored within the parent volume (e.g., the parent volume may comprise data blocks comprising data of 10 files). The parent volume may be cloned to create a cloned volume of the parent volume (e.g., the cloned volume may be “lightweight” because the cloned volume may merely comprise references to the 10 files, such that a reference may be used to retrieve a file from the parent volume for copying into the cloned volume on demand when a user requests access to the file through the cloned volume). The cloned volume may be exposed for read and write access (e.g., a user may modify 2 of the 10 files while testing a software patch, and thus the cloned volume comprises 2 modified files). A cloned volume snapshot of the cloned volume may be generated. A current snapshot of the parent volume may be generated. The cloned volume snapshot may be compared to the current snapshot (e.g., a data block by data block comparison) to identify delta data blocks that are comprised within the cloned volume but are not comprised within the parent volume. For example the delta data blocks may correspond to the 2 modified files that are not common between the parent volume and the cloned volume. The delta data blocks may be copied from the cloned volume to the parent volume (e.g., the parent volume may now comprise the 8 common files that were common between the parent volume and the cloned volume and the 2 modified files copied from the cloned volume so that the parent volume comprises substantially the same data as the cloned volume). Processing resources used for copying data between volumes are reduced, performance may be increased, and client access downtime to data may be decreased because merely the 2 modified files are copied from the cloned volume to the parent volume, as opposed to copying the 8 common files from the parent volume to the cloned volume, unmounting the cloned volume, renaming the cloned volume, and mounting the cloned volume for client access.

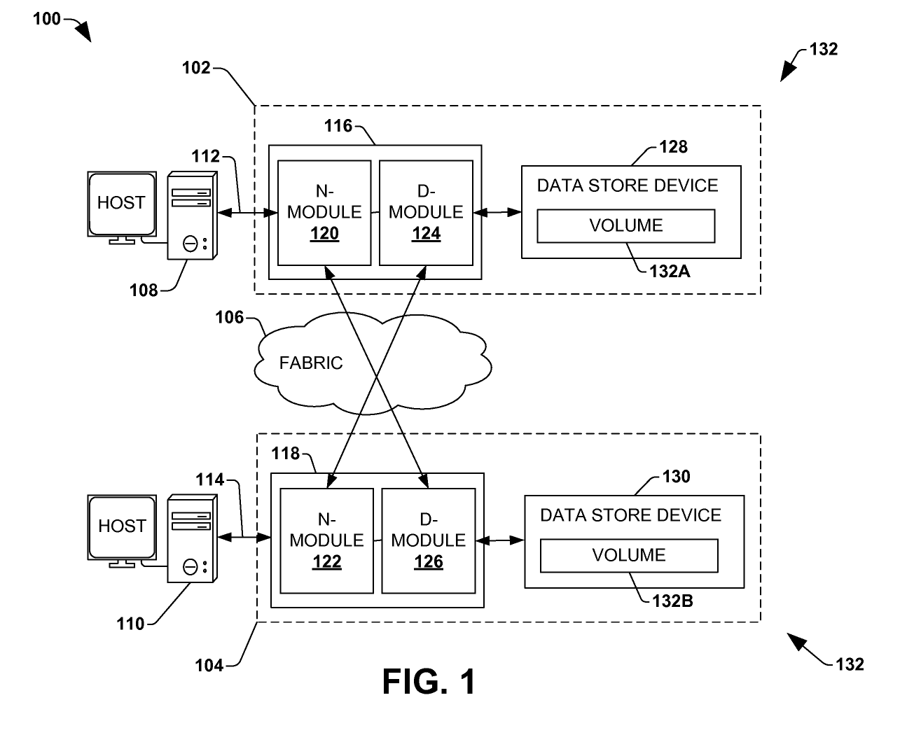

To provide context for clone volume merging, FIG. 1 illustrates an embodiment of a clustered network environment or a network storage environment 100. It may be appreciated, however, that the techniques, etc. described herein may be implemented within the clustered network environment 100, a non-cluster network environment, and/or a variety of other computing environments, such as a desktop computing environment. That is, the instant disclosure, including the scope of the appended claims, is not meant to be limited to the examples provided herein. It will be appreciated that where the same or similar components, elements, features, items, modules, etc. are illustrated in later figures but were previously discussed with regard to prior figures, that a similar (e.g., redundant) discussion of the same may be omitted when describing the subsequent figures (e.g., for purposes of simplicity and ease of understanding).

FIG. 1 is a block diagram illustrating an example clustered network environment 100 that may implement at least some embodiments of the techniques and/or systems described herein. The example environment 100 comprises data storage systems or storage sites 102 and 104 that are coupled over a cluster fabric 106, such as a computing network embodied as a private Infiniband, Fibre Channel (FC), or Ethernet network facilitating communication between the storage systems 102 and 104 (and one or more modules, component, etc. therein, such as, nodes 116 and 118, for example). It will be appreciated that while two data storage systems 102 and 104 and two nodes 116 and 118 are illustrated in FIG. 1, that any suitable number of such components is contemplated. In an example, nodes 116, 118 comprise storage controllers (e.g., node 116 may comprise a primary or local storage controller and node 118 may comprise a secondary or remote storage controller) that provide client devices, such as host devices 108, 110, with access to data stored within data storage devices 128, 130. Similarly, unless specifically provided otherwise herein, the same is true for other modules, elements, features, items, etc. referenced herein and/or illustrated in the accompanying drawings. That is, a particular number of components, modules, elements, features, items, etc. disclosed herein is not meant to be interpreted in a limiting manner.

It will be further appreciated that clustered networks are not limited to any particular geographic areas and can be clustered locally and/or remotely. Thus, in one embodiment a clustered network can be distributed over a plurality of storage systems and/or nodes located in a plurality of geographic locations; while in another embodiment a clustered network can include data storage systems (e.g., 102, 104) residing in a same geographic location (e.g., in a single onsite rack of data storage devices).

In the illustrated example, one or more host devices 108, 110 which may comprise, for example, client devices, personal computers (PCs), computing devices used for storage (e.g., storage servers), and other computers or peripheral devices (e.g., printers), are coupled to the respective data storage systems 102, 104 by storage network connections 112, 114. Network connection may comprise a local area network (LAN) or wide area network (WAN), for example, that utilizes Network Attached Storage (NAS) protocols, such as a Common Internet File System (CIFS) protocol or a Network File System (NFS) protocol to exchange data packets. Illustratively, the host devices 108, 110 may be general-purpose computers running applications, and may interact with the data storage systems 102, 104 using a client/server model for exchange of information. That is, the host device may request data from the data storage system (e.g., data on a storage device managed by a network storage control configured to process I/O commands issued by the host device for the storage device), and the data storage system may return results of the request to the host device via one or more network connections 112, 114.

The nodes 116, 118 on clustered data storage systems 102, 104 can comprise network or host nodes that are interconnected as a cluster to provide data storage and management services, such as to an enterprise having remote locations, for example. Such a node in a data storage and management network cluster environment 100 can be a device attached to the network as a connection point, redistribution point or communication endpoint, for example. A node may be capable of sending, receiving, and/or forwarding information over a network communications channel, and could comprise any device that meets any or all of these criteria. One example of a node may be a data storage and management server attached to a network, where the server can comprise a general purpose computer or a computing device particularly configured to operate as a server in a data storage and management system.

In an example, a first cluster of nodes such as the nodes 116, 118 (e.g., a first set of storage controllers configured to provide access to a first storage aggregate comprising a first logical grouping of one or more storage devices) may be located on a first storage site. A second cluster of nodes, not illustrated, may be located at a second storage site (e.g., a second set of storage controllers configured to provide access to a second storage aggregate comprising a second logical grouping of one or more storage devices). The first cluster of nodes and the second cluster of nodes may be configured according to a disaster recovery configuration where a surviving cluster of nodes provides switchover access to storage devices of a disaster cluster of nodes in the event a disaster occurs at a disaster storage site comprising the disaster cluster of nodes (e.g., the first cluster of nodes provides client devices with switchover data access to storage devices of the second storage aggregate in the event a disaster occurs at the second storage site).

As illustrated in the exemplary environment 100, nodes 116, 118 can comprise various functional components that coordinate to provide distributed storage architecture for the cluster. For example, the nodes can comprise a network module 120, 122 (e.g., N-Module, or N-Blade) and a data module 124, 126 (e.g., D-Module, or D-Blade). Network modules 120, 122 can be configured to allow the nodes 116, 118 (e.g., network storage controllers) to connect with host devices 108, 110 over the network connections 112, 114, for example, allowing the host devices 108, 110 to access data stored in the distributed storage system. Further, the network modules 120, 122 can provide connections with one or more other components through the cluster fabric 106. For example, in FIG. 1, a first network module 120 of first node 116 can access a second data storage device 130 by sending a request through a second data module 126 of a second node 118.

Data modules 124, 126 can be configured to connect one or more data storage devices 128, 130, such as disks or arrays of disks, flash memory, or some other form of data storage, to the nodes 116, 118. The nodes 116, 118 can be interconnected by the cluster fabric 106, for example, allowing respective nodes in the cluster to access data on data storage devices 128, 130 connected to different nodes in the cluster. Often, data modules 124, 126 communicate with the data storage devices 128, 130 according to a storage area network (SAN) protocol, such as Small Computer System Interface (SCSI) or Fiber Channel Protocol (FCP), for example. Thus, as seen from an operating system on a node 116, 118, the data storage devices 128, 130 can appear as locally attached to the operating system. In this manner, different nodes 116, 118, etc. may access data blocks through the operating system, rather than expressly requesting abstract files.

It should be appreciated that, while the example embodiment 100 illustrates an equal number of N and D modules, other embodiments may comprise a differing number of these modules. For example, there may be a plurality of N and/or D modules interconnected in a cluster that does not have a one-to-one correspondence between the N and D modules. That is, different nodes can have a different number of N and D modules, and the same node can have a different number of N modules than D modules.

Further, a host device 108, 110 can be networked with the nodes 116, 118 in the cluster, over the networking connections 112, 114. As an example, respective host devices 108, 110 that are networked to a cluster may request services (e.g., exchanging of information in the form of data packets) of a node 116, 118 in the cluster, and the node 116, 118 can return results of the requested services to the host devices 108, 110. In one embodiment, the host devices 108, 110 can exchange information with the network modules 120, 122 residing in the nodes (e.g., network hosts) 116, 118 in the data storage systems 102, 104.

In one embodiment, the data storage devices 128, 130 comprise volumes 132, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume.

Volumes are typically configured in formats that may be associated with particular storage systems, and respective volume formats typically comprise features that provide functionality to the volumes, such as providing an ability for volumes to form clusters. For example, where a first storage system may utilize a first format for their volumes, a second storage system may utilize a second format for their volumes.

In the example environment 100, the host devices 108, 110 can utilize the data storage systems 102, 104 to store and retrieve data from the volumes 132. In this embodiment, for example, the host device 108 can send data packets to the N-module 120 in the node 116 within data storage system 102. The node 116 can forward the data to the data storage device 128 using the D-module 124, where the data storage device 128 comprises volume 132A. In this way, in this example, the host device can access the storage volume 132A, to store and/or retrieve data, using the data storage system 102 connected by the network connection 112. Further, in this embodiment, the host device 110 can exchange data with the N-module 122 in the host 118 within the data storage system 104 (e.g., which may be remote from the data storage system 102). The host 118 can forward the data to the data storage device 130 using the D-module 126, thereby accessing volume 132B associated with the data storage device 130.

It may be appreciated that clone volume merging, such as a clone volume merge component (e.g. hosted on host devices 108, 110, data storage systems 102, 104, or within any other computing device), may be implemented within the clustered network environment 100. For example, the volume 132A may be a parent volume, and the volume 132B may be created as a cloned volume having a child relationship with the volume 132A. Delta data that is comprised within the volume 132B as the child volume, but not comprised within the volume 132A as the parent volume, may be identified and copied by the clone volume merge component to the volume 132A as the parent volume.

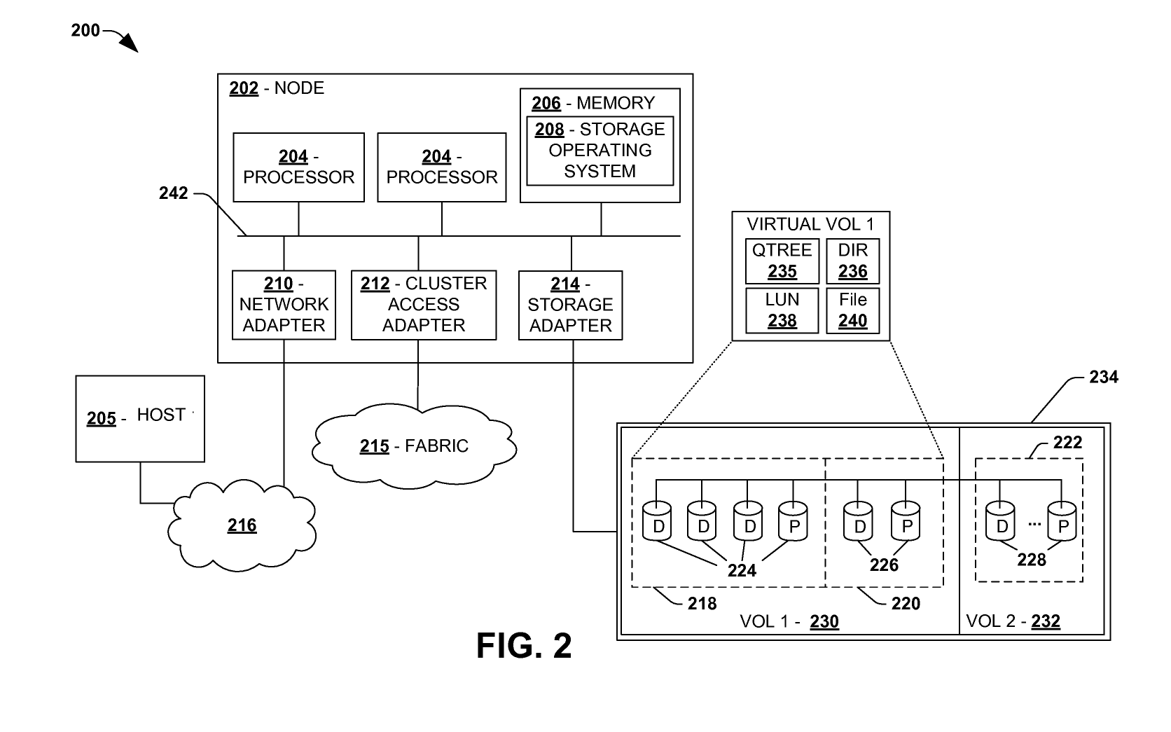

FIG. 2 is an illustrative example of a data storage system 200 (e.g., 102, 104 in FIG. 1), providing further detail of an embodiment of components that may implement one or more of the techniques and/or systems described herein. The example data storage system 200 comprises a node 202 (e.g., host nodes 116, 118 in FIG. 1), and a data storage device 234 (e.g., data storage devices 128, 130 in FIG. 1). The node 202 may be a general purpose computer, for example, or some other computing device particularly configured to operate as a storage server. A host device 205 (e.g., 108, 110 in FIG. 1) can be connected to the node 202 over a network 216, for example, to provides access to files and/or other data stored on the data storage device 234. In an example, the node 202 comprises a storage controller that provides client devices, such as the host device 205, with access to data stored within data storage device 234.

The data storage device 234 can comprise mass storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information.

The node 202 comprises one or more processors 204, a memory 206, a network adapter 210, a cluster access adapter 212, and a storage adapter 214 interconnected by a system bus 242. The storage system 200 also includes an operating system 208 installed in the memory 206 of the node 202 that can, for example, implement a Redundant Array of Independent (or Inexpensive) Disks (RAID) optimization technique to optimize a reconstruction process of data of a failed disk in an array.

The operating system 208 can also manage communications for the data storage system, and communications between other data storage systems that may be in a clustered network, such as attached to a cluster fabric 215 (e.g., 106 in FIG. 1). Thus, the node 202, such as a network storage controller, can respond to host device requests to manage data on the data storage device 234 (e.g., or additional clustered devices) in accordance with these host device requests. The operating system 208 can often establish one or more file systems on the data storage system 200, where a file system can include software code and data structures that implement a persistent hierarchical namespace of files and directories, for example. As an example, when a new data storage device (not shown) is added to a clustered network system, the operating system 208 is informed where, in an existing directory tree, new files associated with the new data storage device are to be stored. This is often referred to as “mounting” a file system.

In the example data storage system 200, memory 206 can include storage locations that are addressable by the processors 204 and adapters 210, 212, 214 for storing related software program code and data structures. The processors 204 and adapters 210, 212, 214 may, for example, include processing elements and/or logic circuitry configured to execute the software code and manipulate the data structures. The operating system 208, portions of which are typically resident in the memory 206 and executed by the processing elements, functionally organizes the storage system by, among other things, invoking storage operations in support of a file service implemented by the storage system. It will be apparent to those skilled in the art that other processing and memory mechanisms, including various computer readable media, may be used for storing and/or executing program instructions pertaining to the techniques described herein. For example, the operating system can also utilize one or more control files (not shown) to aid in the provisioning of virtual machines.

The network adapter 210 includes the mechanical, electrical and signaling circuitry needed to connect the data storage system 200 to a host device 205 over a computer network 216, which may comprise, among other things, a point-to-point connection or a shared medium, such as a local area network. The host device 205 (e.g., 108, 110 of FIG. 1) may be a general-purpose computer configured to execute applications. As described above, the host device 205 may interact with the data storage system 200 in accordance with a client/host model of information delivery.

The storage adapter 214 cooperates with the operating system 208 executing on the node 202 to access information requested by the host device 205 (e.g., access data on a storage device managed by a network storage controller). The information may be stored on any type of attached array of writeable media such as magnetic disk drives, flash memory, and/or any other similar media adapted to store information. In the example data storage system 200, the information can be stored in data blocks on the disks 224, 226, 228. The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fiber Channel Protocol (FCP)). The information is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the host device 205 over the network connection 216 (and/or returned to another node attached to the cluster over the cluster fabric 215).

In one embodiment, storage of information on arrays 218, 220, 222 can be implemented as one or more storage “volumes” 230, 232 that are comprised of a cluster of disks 224, 226, 228 defining an overall logical arrangement of disk space. The disks 224, 226, 228 that comprise one or more volumes are typically organized as one or more groups of RAIDs. As an example, volume 230 comprises an aggregate of disk arrays 218 and 220, which comprise the cluster of disks 224 and 226.

In one embodiment, to facilitate access to disks 224, 226, 228, the operating system 208 may implement a file system (e.g., write anywhere file system) that logically organizes the information as a hierarchical structure of directories and files on the disks. In this embodiment, respective files may be implemented as a set of disk blocks configured to store information, whereas directories may be implemented as specially formatted files in which information about other files and directories are stored.

Whatever the underlying physical configuration within this data storage system 200, data can be stored as files within physical and/or virtual volumes, which can be associated with respective volume identifiers, such as file system identifiers (FSIDs), which can be 32-bits in length in one example.

A physical volume corresponds to at least a portion of physical storage devices whose address, addressable space, location, etc. doesn't change, such as at least some of one or more data storage devices 234 (e.g., a Redundant Array of Independent (or Inexpensive) Disks (RAID system)). Typically the location of the physical volume doesn't change in that the (range of) address(es) used to access it generally remains constant.

A virtual volume, in contrast, is stored over an aggregate of disparate portions of different physical storage devices. The virtual volume may be a collection of different available portions of different physical storage device locations, such as some available space from each of the disks 224, 226, and/or 228. It will be appreciated that since a virtual volume is not “tied” to any one particular storage device, a virtual volume can be said to include a layer of abstraction or virtualization, which allows it to be resized and/or flexible in some regards.

Further, a virtual volume can include one or more logical unit numbers (LUNs) 238, directories 236, qtrees 235, and files 240. Among other things, these features, but more particularly LUNS, allow the disparate memory locations within which data is stored to be identified, for example, and grouped as data storage unit. As such, the LUNs 238 may be characterized as constituting a virtual disk or drive upon which data within the virtual volume is stored within the aggregate. For example, LUNs are often referred to as virtual drives, such that they emulate a hard drive from a general purpose computer, while they actually comprise data blocks stored in various parts of a volume.

In one embodiment, one or more data storage devices 234 can have one or more physical ports, wherein each physical port can be assigned a target address (e.g., SCSI target address). To represent respective volumes stored on a data storage device, a target address on the data storage device can be used to identify one or more LUNs 238. Thus, for example, when the node 202 connects to a volume 230, 232 through the storage adapter 214, a connection between the node 202 and the one or more LUNs 238 underlying the volume is created.

In one embodiment, respective target addresses can identify multiple LUNs, such that a target address can represent multiple volumes. The I/O interface, which can be implemented as circuitry and/or software in the storage adapter 214 or as executable code residing in memory 206 and executed by the processors 204, for example, can connect to volume 230 by using one or more addresses that identify the LUNs 238.

It may be appreciated that clone volume merging, such as a clone volume merge component (e.g. hosted on host device 205, node 202, or within any other computing device), may be implemented for the data storage system 200. For example, the volume 230 may be a parent volume, and the volume 232 may be created as a cloned volume having a child relationship with the volume 230. Delta data that is comprised within the volume 232 as the child volume, but not comprised within the volume 230 as the parent volume, may be identified and copied by the clone volume merge component to the volume 230 as the parent volume.

It may be appreciated that clone volume merging may be implemented for various types of computing environments and/or devices, such as on a laptop device, a server, a general computing device such as a desktop computer, and/or any other computing device or environment that may be capable of storing data within volumes.

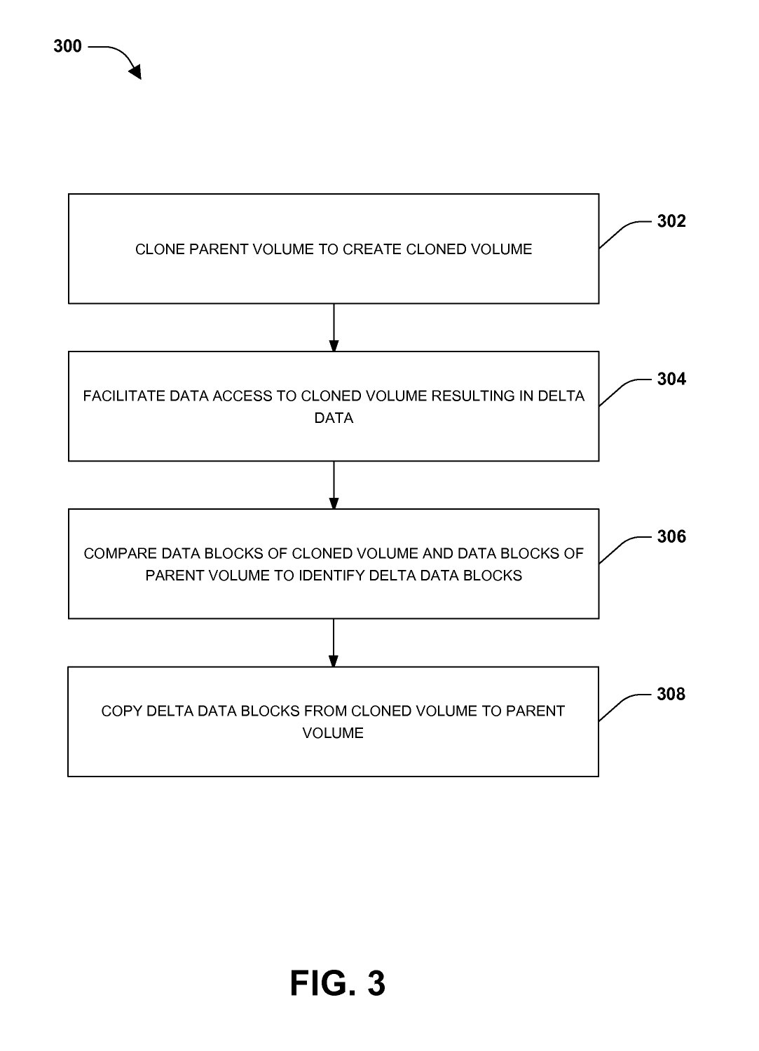

One embodiment of clone volume merging is illustrated by an exemplary method 300 of FIG. 3. A parent volume may be exposed to users for read and write access. In an example, the parent volume may comprise data blocks corresponding to an email server application file, a human resources data database file, a text document file, a photo file, and/or other data (e.g., 50 GB of data). An administrator may want to test a software update for an email server application that stores email server data within the email server application file, and thus the administrator may initiate a cloning operation of the parent volume. Accordingly, at 302, the parent volume is cloned to create a cloned volume of the parent volume. For example, a file system level cloning operation may be performed. In an example, the cloned volume may be configured according to a child relationship with respect to the parent volume (e.g., modifications to the cloned volume and/or data therein are not propagated to the parent volume). The cloned volume may refer to a base parent snapshot of the parent volume (e.g., a snapshot of a file system of the parent volume at a point in time). Thus, the cloning operation may configure the cloned volume to refer to parent data of the parent volume (e.g., the email server application file, the human resources data database file, the text document file, the photo file, etc.) by referring to the base parent snapshot for access to the parent data, as opposed to the cloning operation copying the parent data into the cloned volume. In this way, the cloned volume may expose access to the parent data (e.g., a reference may be used to copy parent data into the cloned volume on demand when access to the parent data is requested through the cloned volume) without the cloned volume initially comprising copies of the parent data (e.g., the cloned volume may appear to users as if the cloned volume actually comprises the email server application file, the human resources data database file, the text document file, the photo file, etc.), which may significantly reduce an amount of storage space used by the cloned volume (e.g., the cloned volume may initially comprise references to the 50 GB of parent data as opposed to comprising a copy of the 50 GB parent data).

It may be appreciated that in another example, the clone operation may create copies of the parent data, of the parent volume, within the cloned volume. Thus, the cloned volume may comprise copies of 50 GB parent data as opposed to references to the 50 GB parent data within the parent volume.

At 304, data access to the cloned volume may be facilitated. The data access may result in delta data comprised within the cloned volume but not within the parent volume because of the child relationship. For example, the administrator may apply the software update to the cloned volume. The software update may request to update the email server application file to create an updated email server application file. Because the email server application file is exposed through the cloned volume but is actually located within the parent volume (e.g., the email server application file is parent data whose data blocks are stored within the parent volume but are referenced by the cloned volume through the base parent snapshot), the email server application file is copied from the parent volume to the cloned volume as a copied email server application file. The software update may be applied to the copied email server application file within the cloned volume to create the updated email server application file within the cloned volume. Because the updated email server application file is comprised within the cloned volume and not the parent volume, the updated email server application file may be considered delta data (e.g., modifications to the cloned volume are not propagated to the parent volume because the parent volume may be in production where users may be accessing the parent volume, such as requesting new emails from the email server application, editing the text document file, accessing the human resources database file using a human resources application, etc.).

The administrator may determine that the software update was a success and is ready for production. At 306, data blocks of the cloned volume and data blocks of the parent volume are compared to identify delta data blocks corresponding to the delta data. For example, a cloned volume snapshot of the cloned volume is generated (e.g., a snapshot of a file system of the cloned volume at a point in time). A snapshot of the parent volume is generated (e.g., a snapshot of a file system of the parent volume at a point in time). The cloned volume snapshot and the snapshot may be compared to identify the delta data blocks. In an example, the delta data blocks correspond to the updated email server application file comprised within the cloned volume but not the parent volume.

At 308, the delta data blocks are copied from the cloned volume to the parent volume. In an example, the copying may be performed responsive to a determination that the size of the delta data blocks is smaller than common data blocks (e.g., data blocks that are common to both the parent volume and the cloned volume), which may reduce an amount of time and processing resources used to generate a volume comprising both the common data blocks and the delta data block because a smaller amount of data is being copied, thus decreasing downtime for end users. In an example, the delta data blocks are copied while the parent volume is mounted for client access. In another example, the name of the parent volume is retained during and/or after the copying (e.g., the copying may result in a modified parent volume that retains the name of the parent volume), which may reduce user access downtime to the parent volume because the parent volume does not need to be unmounted, renamed, and remounted. In an example, the child relationship may be removed from the cloned volume (e.g., and/or the cloned volume may be deleted) based upon a copy operation success of the copy operation. In an example, a current snapshot of the parent volume may be generated before the copying. If a copy operation failure of the delta data blocks occurs, then the parent volume may be restored utilizing the current snapshot. In this way, the delta data may be merged into the parent volume in an efficient manner.

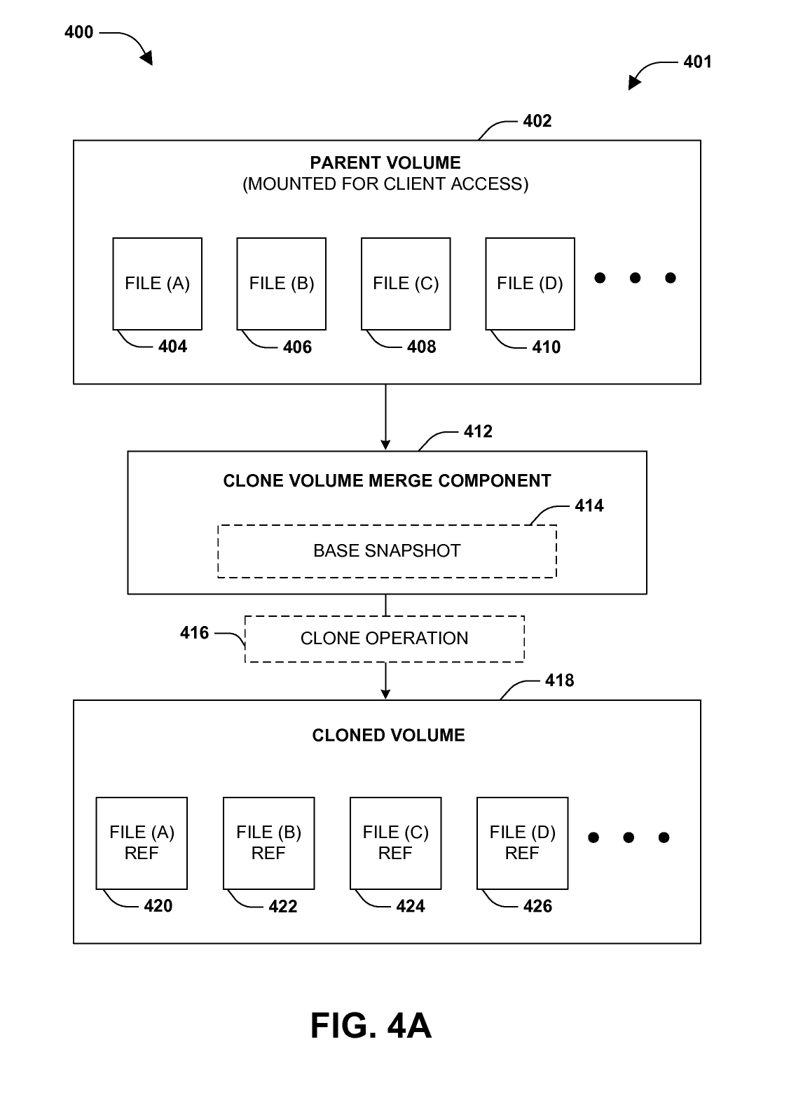

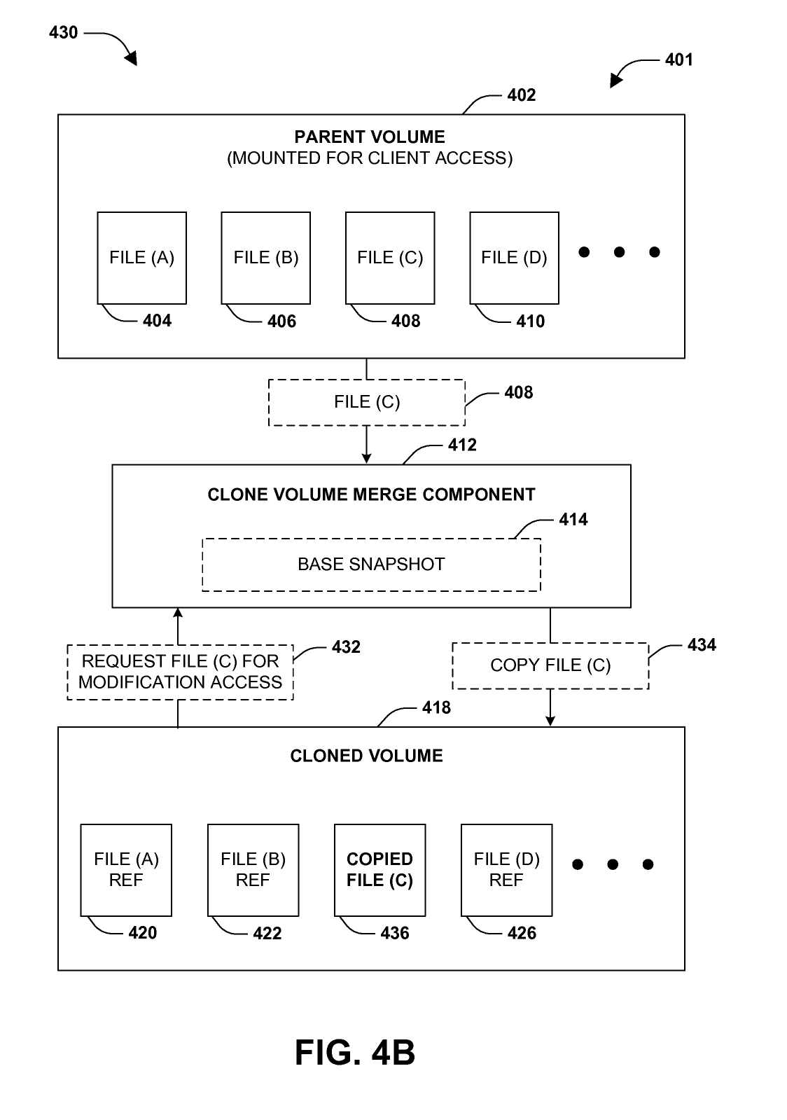

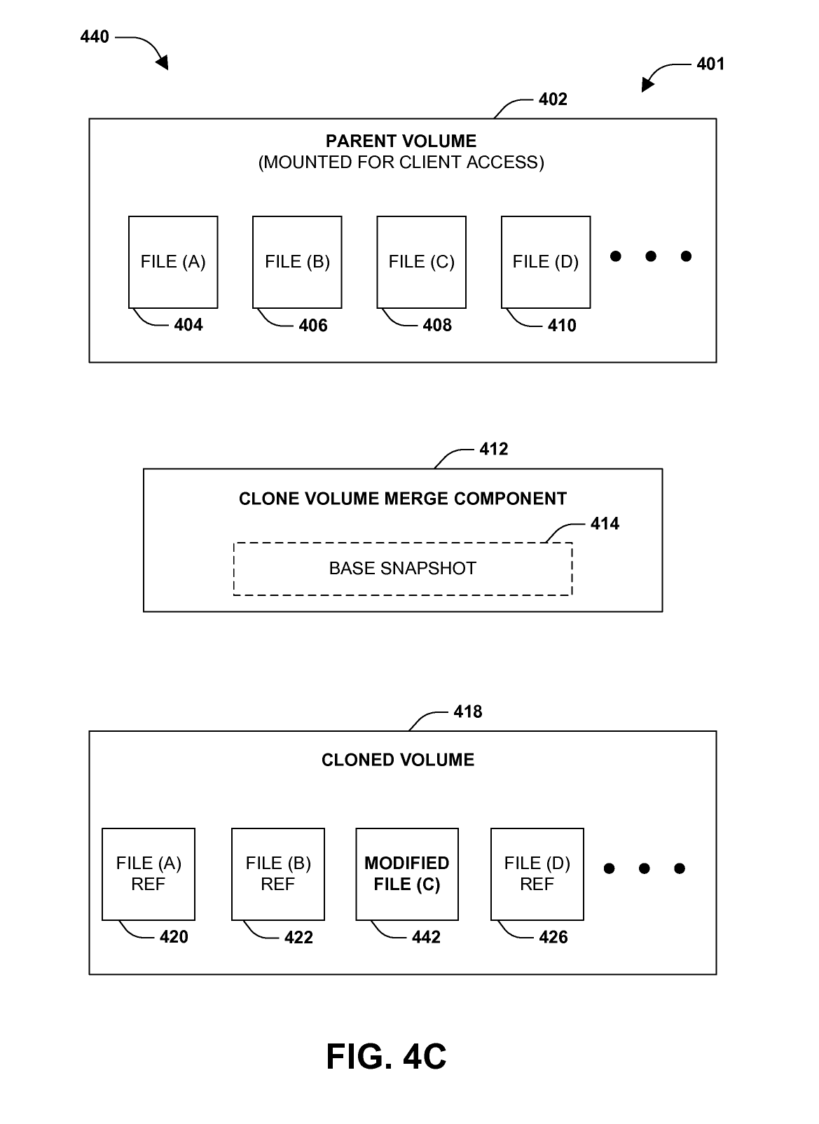

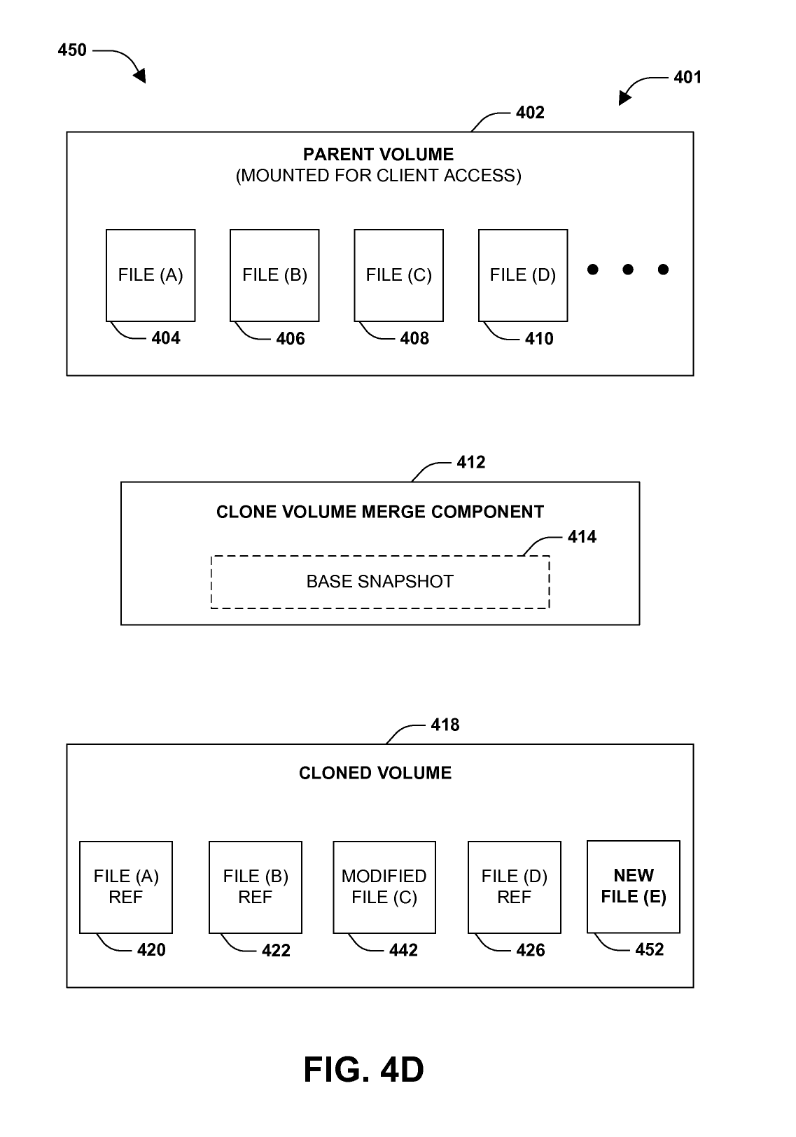

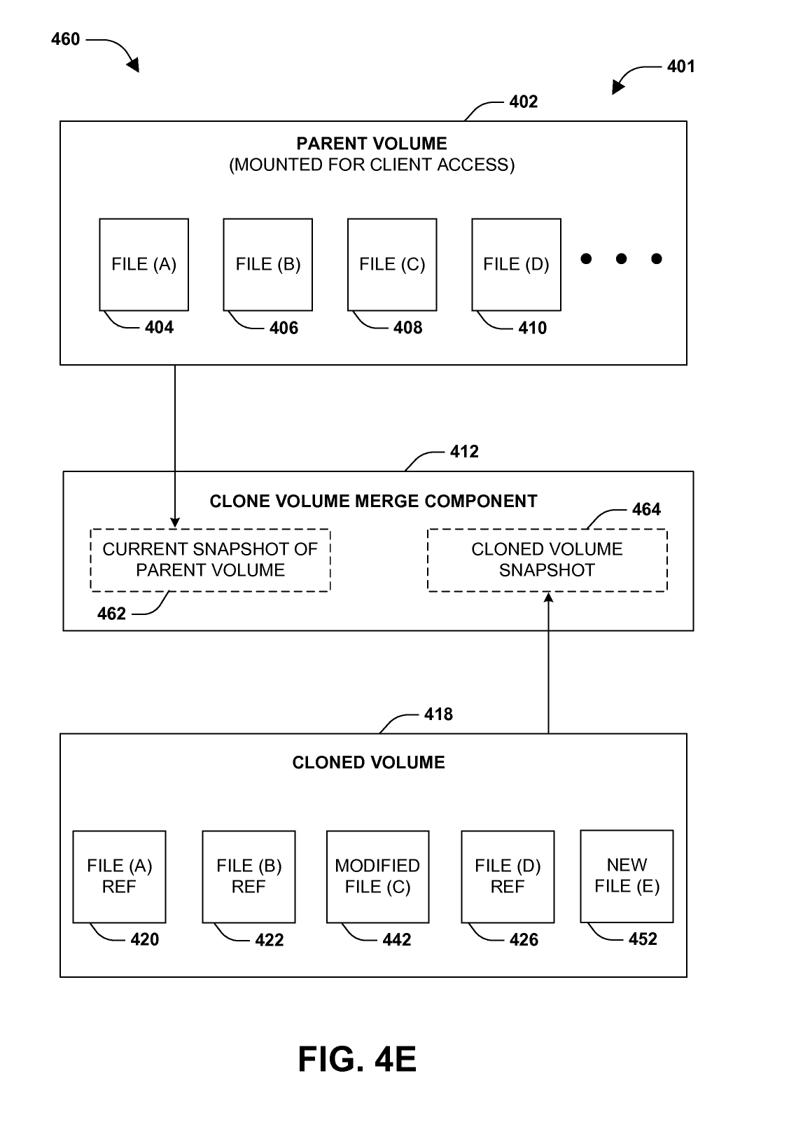

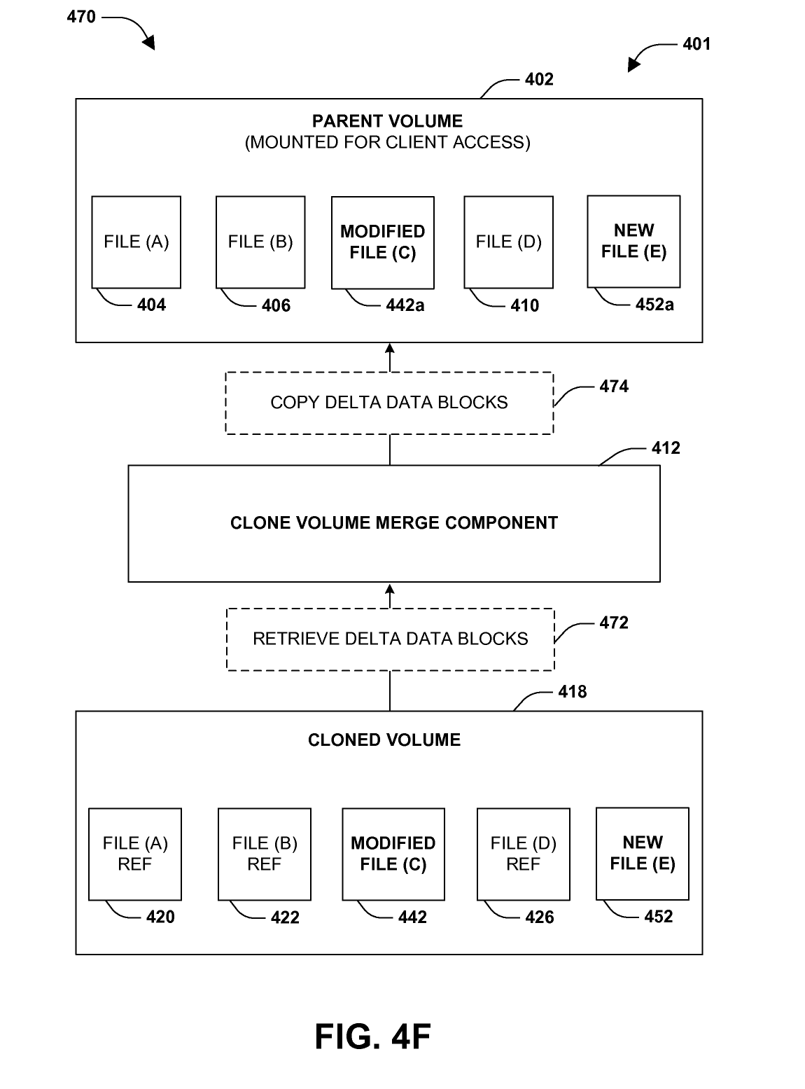

FIGS. 4A-4F illustrate examples of a system 401, comprising a clone volume merge component 412, for clone volume merging. FIG. 4A illustrates a parent volume 402 that is in production, such as mounted for client access to data within the parent volume 402. The parent volume 402 may comprise data blocks of a file (A) 404, a file (B) 406, a file (C) 408, a file (D) 410, and/or other files. The clone volume merge component 412 may be configured to generate a base snapshot 414 of the parent volume 402 (e.g., a snapshot of a file system of the parent volume 402 at a point in time). The clone volume merge component 412 may perform a clone operation 416 on the parent volume 402 to create a cloned volume 418. The cloned volume 418 may be configured according to a child relationship with the parent volume 402 (e.g., changes to the cloned volume 418 are not propagated to the parent volume 402 in order to preserve the integrity of the parent volume 402). In an example, the cloned volume 418 may refer to the base snapshot 414, and thus may comprise a file (A) reference 420 to the file (A) 404, a file (B) reference 422 to the file (B) 406, a file (C) reference 424 to the file (C) 408, a file (D) reference 426 to the file (D) 410, etc. That is, the cloned volume 418 may comprises references, through the base snapshot 414, to parent data of the parent volume 402 (e.g., file (A) 404, file (B) 406, and/or other parent data within the parent volume 402), as opposed to comprising copies of the parent data, which may reduce storage used by the cloned volume 418 because a reference may comprise a significantly smaller amount of data than the actual parent data to which the reference refers. In this way, the cloned volume 418 may be exposed to users as providing access to the file (A) 404, the file (B) 406, the file (C), the file (D) 410, and/or other parent data even though the cloned volume 418 does not comprise the parent data but merely comprises references used to retrieve the parent data.

It may be appreciated that in another example, the clone operation 416 may create copies of the parent data, of the parent volume 402, within the cloned volume 418. Thus, the cloned volume 418 may comprise copies of the file (A) 404, the file (B) 406, the file (C) 408, and the file (D) as opposed to references to such parent files within the parent volume 402.

FIG. 4B illustrates an example 430 of processing a request, through the cloned volume 418, to access the file (C) 408. For example, the file (C) 408 may comprise a database application file. A database administrator may attempt to open the database application file through the cloned volume 418. Accordingly, the file (C) reference 424 may be used to request 432 the file (C) 408 from the parent volume 402. The file (C) 408 may be copied 434 to the cloned volume 418 as a copied file (C) 436. In this way the database administrator may be given read and write access to the copied file (C) 436 comprised within the cloned volume 418.

FIG. 4C illustrates an example 440 of the database administrator modifying the copied file (C) 436. For example, the database administrator may apply a software update to a database application, which may modify the copied file (C) 436 (e.g., add, remove, and/or replace data within the copied file (C) 436). In this way, a modified file (C) 442 within the cloned volume may result from the software update. Because the cloned volume 418 may be configured according to the child relationship, the modification to the copied file (C) 436 is not propagated to the file (C) 408 within the parent volume 402. Thus, the modified file (C) 442 may be delta data that is comprised within the cloned volume 418 but not the parent volume (e.g., data blocks of the modified file (C) 442 that do not correspond to data blocks of the file (C) 408 may be determined as delta data blocks).

FIG. 4D illustrates an example 450 of the database administrator writing a new file (E) 452 to the cloned volume 418. Because the cloned volume 418 may be configured according to the child relationship, the new file (E) 452 is not propagated to the parent volume 402. In this way, the parent volume 402, which may be mounted for client access (e.g., the database application may be currently providing users with access to data stored within a database), may be unaffected by changes to the cloned volume 418.

FIG. 4E illustrates an example 460 of the clone volume merge component 412 implementing a clone volume merge operation. The clone volume merge component 412 may generate a current snapshot 462 of the parent volume 402 (e.g., a snapshot of a file system of the parent volume 402 at a point in time). The clone volume merge component 412 may generate a cloned volume snapshot 464 of the cloned volume 418 (e.g., a snapshot of the file system of the cloned volume 418 at a point in time). The clone volume merge component 412 may compare the cloned volume snapshot 464 to the current snapshot 462 (e.g., comparison of data blocks; comparison of inodes or data blocks in inode buffer streams; etc.) to identify delta data blocks comprised within the cloned volume 418 but not comprised within the parent volume 402. For example, the delta data blocks may correspond to the modified file (C) 442 and the new file (E) 452 that are comprised within the cloned volume 418 but not the parent volume 402.

In another example, the base snapshot 414 may be locked in the cloned volume 418 as the child volume so that the base snapshot 414 cannot be deleted. A latest snapshot may be taken of the cloned volume 418 (e.g., the current snapshot 462). The delta data blocks may be derived from the latest snapshot, such as the current snapshot 462, and the base snapshot 414. The base snapshot 414 may be restored on the parent volume 402. The delta data blocks may be copied to the parent volume 402.

FIG. 4F illustrates an example 470 of the clone volume merge component 412 implementing the clone volume merge operation. The clone volume merge component 412 may retrieve 472 the delta data blocks, such as data blocks of the modified file (C) 442 and the new file (E) 452, from the cloned volume 418. The clone volume merge component 412 may copy 474 the delta data blocks to the parent volume 402, resulting in the parent volume 402 comprising a modified file (C) 442a and a new file (E) 452a. In an example, the delta data blocks may be copied 474 while the parent volume 402 is mounted and without renaming the parent volume 402, which may mitigate client access downtime to data within the parent volume 402.

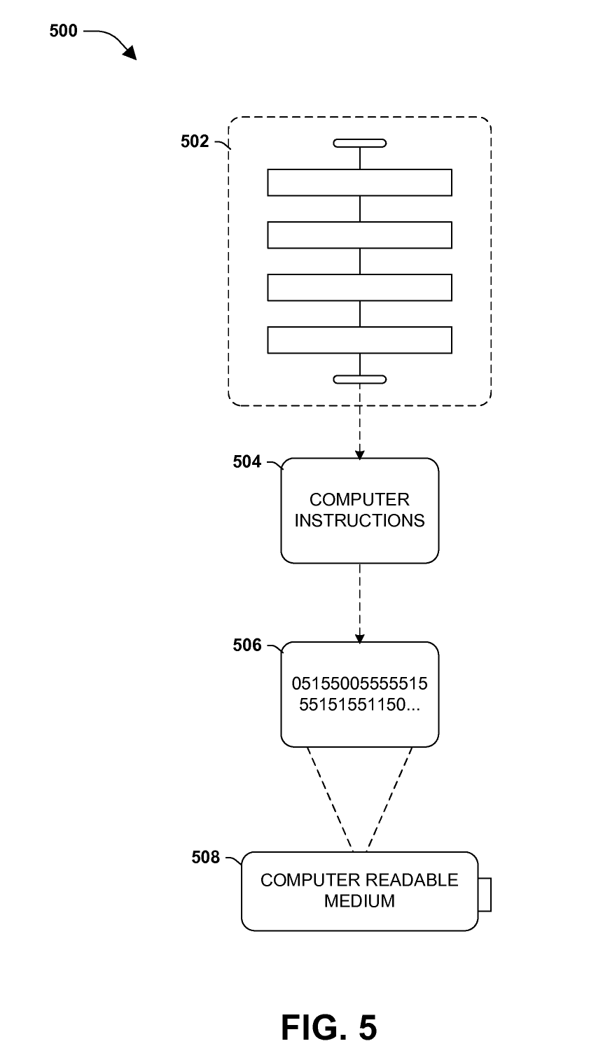

Still another embodiment involves a computer-readable medium comprising processor-executable instructions configured to implement one or more of the techniques presented herein. An example embodiment of a computer-readable medium or a computer-readable device that is devised in these ways is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the processor-executable computer instructions 504 are configured to perform a method 502, such as at least some of the exemplary method 300 of FIG. 3, for example. In some embodiments, the processor-executable instructions 504 are configured to implement a system, such as at least some of the exemplary system 401 of FIGS. 4A-4F, for example. Many such computer-readable media are contemplated to operate in accordance with the techniques presented herein.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for clone volume merging, comprising:
cloning a parent volume to create a cloned volume of the parent volume;
facilitating data access to the cloned volume resulting in delta data comprised within the cloned volume, the delta data not comprised within the parent volume;
comparing data blocks of the cloned volume and data blocks of the parent volume to identify delta data blocks corresponding to the delta data; and
copying the delta data blocks from the cloned volume to the parent volume.

2. The method of claim 1, the comparing comprising:
generating a cloned volume snapshot of the cloned volume; and
comparing the cloned volume snapshot to a snapshot of the parent volume to identify the delta data blocks.

3. The method of claim 1, the copying comprising:
generating a current snapshot of the parent volume; and
responsive to a copy operation failure of the delta data blocks, restoring the parent volume utilizing the current snapshot.

4. The method of claim 1, the cloning comprising:
generating a base parent snapshot of the parent volume; and
configuring the cloned volume to refer to the base parent snapshot according to a child relationship with respect to the parent volume.

5. The method of claim 1, the cloning comprising:
exposing access, through the cloned volume, to parent data comprised within the parent volume and referenced by the cloned volume, the parent data not comprised within the cloned volume.

6. The method of claim 5, the facilitating data access comprising:
responsive to receiving a request, through the cloned volume, to access the parent data:
copying the parent data from the parent volume to the cloned volume as copied data; and
providing access, through the cloned volume, to the copied data.

7. The method of claim 1, the cloning comprising:
performing a file system level cloning operation.

8. The method of claim 1, the copying comprising:
copying the delta data blocks while the parent volume is mounted for client access.

9. The method of claim 1, the copying resulting in a modified parent volume, and the copying comprising:
retaining a name of the parent volume for the modified parent volume.

10. The method of claim 1, the copying comprising:
identifying common data blocks that are common between the parent volume and the cloned volume; and
responsive to the common data blocks having a size exceeding the delta data blocks, performing the copying.

11. The method of claim 4, the copying comprising:
removing the child relationship from the cloned volume to the parent volume based upon success of a copy operation of the delta data blocks.

12. A system for clone volume merging, comprising:
a clone volume merge component configured to:
clone a parent volume to create a cloned volume of the parent volume;
generate a cloned volume snapshot of the cloned volume;
generate a current snapshot of the parent volume;
compare the cloned volume snapshot to the current snapshot to identify delta data blocks comprised within the cloned volume and not comprised within the parent volume; and
copy the delta data blocks from the cloned volume to the parent volume.

13. The system of claim 12, the clone volume merge component configured to:
perform a file system level cloning operation to clone the parent volume.

14. The system of claim 12, the clone volume merge component configured to:
retain a name of the parent volume for the parent volume after the delta data blocks are successfully copied to the parent volume.

15. The system of claim 12, the clone volume merge component configured to:
copy the delta data blocks while the parent volume is mounted for client access.

16. The system of claim 12, the clone volume merge component configured to:
identify common data blocks that are common between the parent volume and the cloned volume; and
responsive to the common data blocks having a size exceeding the delta data blocks, copy the delta data blocks.

17. The system of claim 12, the clone volume merge component configured to:
expose access, through the cloned volume, to parent data comprised within the parent volume and referenced by the cloned volume, the parent data not comprised within the cloned volume.

18. The system of claim 12, the clone volume merge component configured to:
responsive to receiving a request, through the cloned volume, to access the parent data:
copy the parent data from the parent volume to the cloned volume as copied data; and
provide access, through the cloned volume, to the copied data.

19. The system of claim 12, the clone volume merge component configured to:
generate a base parent snapshot of the parent volume; and
configure the cloned volume to refer to the base parent snapshot according to a child relationship with respect to the parent volume.

20. A computer readable medium comprising instructions which when executed perform a method for clone volume merging, comprising:
cloning a parent volume to create a cloned volume of the parent volume;
generating a cloned volume snapshot of the cloned volume;
generating a current snapshot of the parent volume;
comparing the cloned volume snapshot to the current snapshot to identify delta data blocks comprised within the cloned volume and not comprised within the parent volume; and
copying the delta data blocks from the cloned volume to the parent volume.
